(19) United States
(12) Patent Application Publication
(10) Pub. No.: US 2025/0127100 A1
(43) Pub. Date: Apr. 24, 2025

(54) SOIL CONDUIT DESIGN AND ARCHITECTURE

(71) Applicant: Vanessa P. Harden, Cambridge, MA (US)

(72) Inventor: Vanessa P. Harden, Cambridge, MA (US)

(21) Appl. No.: 18/826,046

(22) Filed: Sep. 5, 2024

Related U.S. Application Data
(60) Provisional application No. 63/592,918, filed on Oct. 24, 2023.

(51) Int. Cl. A01G 17/00

(52) U.S. Cl. CPC A01G 17/005

(57) ABSTRACT

Soil conduits are constructed between tree pits in an urban environment. These soil conduits extend upward to the surface, are covered by grates, and are permeable to allow the seepage of water and nutrients to tree roots in the tree pits. The soil conduits include, from the surface moving downward, mulch, horticultural soil, a fabric barrier, and crushed stone. The horticultural soil is inoculated with mycorrhizal fungus that creates fungal networks between the roots of various trees, communicating water and nutrients between the roots of the connected trees. These fungal networks increase the health, carbon dioxide consumption and oxygen production of urban trees. Various planting schemes could be employed such as using trees and bushes to create a common mycorrhizal network (CMN) which is associated with arbuscular mycorrhizae (AM), using plants that associate with ectomycorrhizae (ECM), or using plants associated with both types of fungus networks.

### CROSS-REFERENCE TO RELATED APPLICATION

This application claims the benefit of U.S. Patent Application 63/592,918, filed on Oct. 24, 2023, “SOIL CONDUIT ARCHITECTURE” by Vanessa Harden, the disclosure of which is incorporated by reference in its entirety to provide continuity of disclosure to the extent such disclosure is not inconsistent with the disclosure herein.

### FIELD OF THE INVENTION

The present invention relates to a method and system for designing urban forests to improve the health of urban trees, and, more specifically, it relates to a method and system for designing urban structures to improve the health of urban trees to increase the advantages provided by healthy urban trees.

### BACKGROUND OF THE INVENTION

### Urban Trees (Canopy) Provide Advantages

Trees in urban areas, which may be referred to as Urban Forests, play many vital roles in urban life for both humans and non-humans, with benefits that can be divided into three categories-environmental benefits, social benefits, and economic benefits. These benefits include reducing carbon dioxide, increasing breathable oxygen in the atmosphere, mitigating urban heat islands and reducing buildings' energy in densely built-up areas, helping control stormwater runoff, assisting in reducing wildfire risks, improving overall human health, augmenting community interaction, and increasing property values and increasing species biodiversity of urban fauna by providing habitat, food, and landscape connectivity.

### Urban Forests are not Healthy as Rural Forests

Urban street trees have a higher turnover and mortality compared to rural forests. Lara Roman discusses the link between tree planting and tree survival and the decline of the overall tree canopy in the United States, Roman, L. A., Battles, J. J., McBride, J. R., 2013, “The balance of planting and mortality in a street tree population”. Urban Ecosyst. 17, 387-404. https://doi.org/10.1007/s11252-013-0320-5. Roman references a study by Jacqueline Lu's in 2010 which found that 26.2 percent of NYC street trees die eight to nine years after planting. Based on her analysis of eleven of her previous studies, Roman found that the typical street tree mean life expectancy is nineteen to twenty-eight years, with an annual mortality rate of 3.5 percent to 5.1 percent.

With these numbers, one can determine that the population half-life is thirteen to twenty years, which means that for every hundred trees planted, only fifty will survive for thirteen to twenty years. Roman writes “Planting a few hundred trees, or even a million, does not automatically translate to an increase in the overall tree population over the long term. To increase population levels, the survival and planting rates must outweigh losses from tree death and removal, including both old and young individuals” (Roman 2014).

Currently, there is a need to increase the health of urban forests to decrease CO2 accumulation, increase oxygen production, increase shade, reduce temperature, and decrease erosion in urban areas.

### SUMMARY OF THE INVENTION

The current invention may be embodied as a method for creating more resilient urban forests by performing the steps of digging a tree pit, planting a root ball of a tree in the tree pit for a plurality of trees, digging a plurality of soil conduits extending from the root ball toward a root systems of other urban trees, inoculating soil with mycorrhizal fungi, and at least partially filling the soil conduits with soil inoculated with the mycorrhizal fungi.

The current invention may also be embodied as a more resilient tree architecture in an urban environment having a number of soil conduits extending between the roots of the urban trees in an urban environment, wherein the soil conduits are inoculated with a mycorrhizal fungus and form fungal networks between roots of the urban trees.

The current invention may also be embodied as an urban vegetation arrangement having a number of plants known to interrelate with a mycorrhizal fungus planted in various locations within an urban environment, a plurality of soil conduits connecting roots of the plants, wherein the soil conduits are shallow, elongated passages that open to the surface, and are filled with a soil conducive to root growth inoculated with the mycorrhizal fungus. The soil conduits have an air and water permeable solid structure on their top sides functioning to prevent compaction of the contents of the materials in the soil conduits.

### BRIEF DESCRIPTION OF THE DRAWINGS

Some embodiments of the present invention are illustrated as examples and are not limited by the figures of the accompanying drawings, in which like references may indicate similar elements and in which:

FIG. 1 is an elevational, partial cross-sectional view perpendicular to the length of the elongated soil conduits used to increase an urban forest's health according to an embodiment of the current invention.

FIG. 2 is an enlarged view of one of the soil conduits of FIG. 1.

FIG. 3 is an enlarged perspective view of another embodiment of a soil conduit according to the present invention.

FIG. 4 is an elevational, partial cross-sectional view through the length of the elongated soil conduit features used to increase an urban forest's health according to one embodiment of the current invention.

FIG. 5 is a plan view showing six conduits connecting three trees in series to increase the health of an urban forest according to one embodiment of the current invention.

FIG. 6 is a side elevational view of a partially cut-away drawing of three trees connected by soil conduits.

FIG. 7 is an example of a common mycorrhizal network (CMN) mycorrhizal planting scheme having an overstory of AM-associated Acer spp. and pyrus trees with an understory of smaller AM shrubs such as rubus or digitalis.

FIG. 8 shows a configuration that includes only ECM pairing of trees and shrubs, which could encourage the formation of a second CMN.

FIG. 9 shows the CMNs of FIGS. 7 and 8 in close proximity to each other but not interrelating.

FIG. 10 shows a planting scheme employing plants associated with more than one type of mycorrhiza, which acts as a bridge between ECM and AM plants.

FIG. 11 is a side elevational view of a partially cut-away drawing of one tree pit connecting to a neighboring tree through a soil conduit.

FIG. 12 shows the dimensions of the pots used in the experiments and the depth of their contents.

FIG. 13 is a diagram showing the dimensions of a wooden soil conduit connecting two wooden boxes used in the experiments.

FIG. 14 is a diagram showing the dimensions of another wooden soil conduit used in the experiments.

### DETAILED DESCRIPTION OF THE INVENTION

The terminology used herein is to describe particular embodiments only and is not intended to be limiting to the invention. As used herein, the term “and/or” includes all combinations of one or more of the associated listed items. As used herein, singular forms “a”, “an”, and “the” are intended to include the plural forms as well as the singular forms unless the context indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that several techniques and steps are disclosed. Each of these has individual benefits, and each can also be used in conjunction with one or more, or in some cases all, of the other disclosed techniques. Accordingly, for clarity, this description will refrain from repeating every possible combination of individual steps unnecessarily. Nevertheless, the specification and claims should be read with the understanding that such combinations are entirely within the scope of the invention and the claims.

### 1. Theory

How Urban Forests Differ from Rural Forests

There are many factors that make being a tree in an urban environment a difficult existence. There are studies of tree mortality that indicated that the most common ecological factors were related to tree species, tree size or age, and site characteristics. There was a study conducted in 1990 in Oakland, California, of newly planted street trees to record their growth and mortality rates. It was found that after two years, 34 percent of the trees had either died or been removed. In another study of young New York City Street trees, it was found that land use was a large contributing factor in mortality. Trees that were planted on private property had a higher survival rate (82.7 percent) than those planted on the street (60.3 percent to 62.9 percent). Forestry managers and city residents have reported that infrastructural damage is one of the main reasons for tree mortality.

### Root Space

Urban trees experience a lack of room for roots, according to research done by Urban J., 2008. Up by Roots. International Society of Arboriculture, Atlanta, Georgia.

As they grow, trees and their roots are forced to compete for space in an urban environment resulting in damage to city infrastructure. Lack of space is one of the biggest challenges facing street trees.

### Permeable Soil

Trees require loose and porous soil to be able to grow and move, whereas most urban infrastructure is built to withstand loads such as cars and humans. It is known that soil compaction creates a problem for trees because it limits the porous soil space through which roots expand.

Most prior art urban trees have pavement, sidewalks, and other non-permeable surfaces surrounding them. These non-permeable surfaces restrict the flow of surface water and nutrients downward to the roots of the urban trees.

### Lack of Organic Matter

Urban trees also experience a lack of decomposing matter. Leaves and other organic material in urban settings that fall on pavement, sidewalks, or concrete is either blown away or raked up to clear streets and sidewalks. Therefore, there is a lack of organic material in urban settings.

In rural settings, this organic material decomposes and creates organic fertilizers with nutrients for the trees. This organic material is processed by microbes and fungi in the soil. There are also mycorrhizal fungi and other fungi (mycorrhizae) which work symbiotically with the trees and form fungi networks between the roots of a tree and the roots of different trees linking them together.

It is important to recognize the link between mycorrhizae and the conditions mentioned in tree mortality and reflect on the effects that urbanization has on the quality of the soil. There are fewer mycorrhizae in urban soil, which we know promotes nutrient transfer between trees. This was described by Bainard, L. D., Klironomos, J. N., Gordon, A. M., 2010. The mycorrhizal status and colonization of 26 tree species growing in urban and rural environments. Mycorrhiza 21, 91-96. https://doi.org/10.1007/s00572-010-0314-6. Therefore, we can assume that healthy trees grow in fertile soil, which most likely contains mycorrhizal fungi (among other organisms).

Based on this mutualistic relationship between organisms, we naturally expect that mycorrhizal fungi would benefit substantially from improved design and maintenance practices that are geared towards decreasing tree mortality.

Prior studies have shown the challenges urban trees also face de-icing salts, higher temperatures, and air pollution. With better maintenance plans and improved infrastructure design, some of the challenges that street trees face could be decreased significantly.

Studies have shown that increasing GI in cities promotes the broader sustainability agenda through ecosystem services such as ‘greenways,’ which emphasize the concept of resilience through connectivity. A new ‘greenway’ links trees in cities through underground corridors to facilitate mycorrhizal connectivity, which scientists have confirmed do benefit the health of trees. Inspired by nature, the soil conduit is a form of biomimicry that aims to create human-made channels that allow for mycorrhizal fungi to connect to the root systems of neighboring plants.

To understand how trees could connect in the city, trenching, to counter the effects of soil compaction in urban environments, was explored as a way of creating a corridor where roots could extend towards each other. With soil compaction in the urban (‘built’) environment being one of the many challenges that urban trees and their root systems have to endure, root paths, a form of trenching was developed to support root health by providing more space for them to expand.

### 2. Implementation

Applied Theory; Informing Design with Nature

Understanding how nature works from an ecological standpoint is vital to understanding the role that landscape architecture should be playing, not only in a rural context but also in the urban environment.

Sitting at the surface of the ground and protected by a metal grate, a soil conduit should extend from one tree pit and connect to another. The soil conduit is disclosed through detailed drawings and descriptions of the various components that make up this design.

### Making Space

The Silva Cell, a design developed by Deep Root, promotes tree root health (and by association mycorrhizal fungal health) by creating space for the roots to grow out and expand. This design is a “modular suspended pavement system that holds unlimited amounts of lightly compacted soil while supporting traffic loads beneath paving”. In James Urban's “Up by the Roots” (2008) root paths and conduits are addressed in detail, demonstrating how to build infrastructure with conduits that help prevent compaction and enable the tree roots to spread (Urban 2008). (As indicated above, we will be referring to conduits as “soil conduits”.) Although this method is specific to roots and does not mention mycorrhizal fungi, we believe this method can be used for the purpose of this literature review because it promotes healthy soil. This in turn automatically supports and promotes mycorrhizal fungi that live in and around the roots. Therefore, soil conduits are required in the current design to promote tree connectivity.

### Root Paths

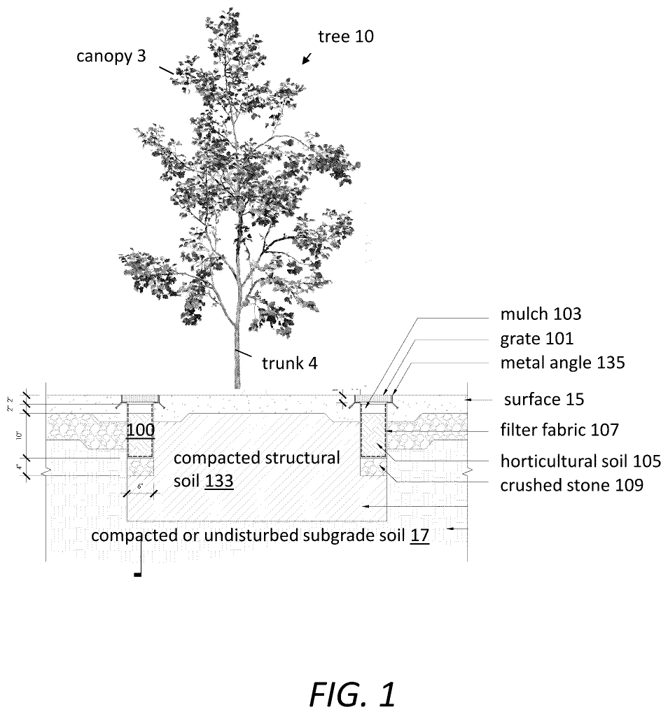

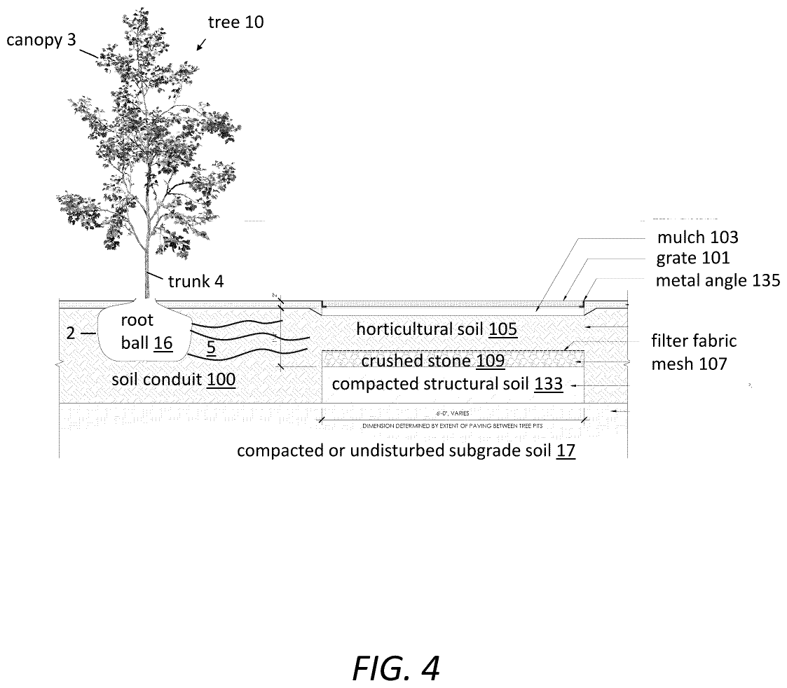

The current invention employs root paths as a low-cost method of steering roots outward from the tree pit to give them more space. A proposed root path starting adjacent to roots of a tree in an urban environment and extending away from the tree as shown in FIGS. 1 and 4. A typical root path would be a conduit 4 inches wide by 12 inches deep and is filled with strip drainage material and topsoil. The intent with this novel design is to give roots an opportunity to expand beyond the tree pit to access more resources and oxygen through these “aeration pathways.” According to Urban, the geotextile around the strip drain helps retain oxygen as well as providing an excellent surface for the roots to grow on. Root paths are an efficient way to guide roots under pavement to lawn and garden areas on the other side of the walk. (Urban, 2008, 297). A trenching machine is used to dig the root path and then to add a strip drain in the middle of the channel, which is filled with quality topsoil.

### Structured Soils

Structured soils are being designed specifically for urban environments to withstand the weight of vehicles and humans while also attempting to retain water and create enough space for root expansion. With root damage caused by site conditions such as soil compaction, one of the leading causes of mortality, the importance of addressing the underground environment is vital. We must remember that damage to the roots comes with damage to the organisms that live on and in the roots such as mycorrhizal fungi. This is one of the reasons why soil volume is an important factor to consider when designing the space needed to foster the health of a tree. The amount of soil needs to be tailored to the tree species and its expected size at maturity. Researchers have created a methodology for calculating the correct soil volume required to support a specific tree which has a major impact on survivability.

Researchers conducted a study and found that of all treatments, suspended pavement over non-compacted soils is best suited to promote the health and growth of street trees. However, these ideal conditions are often unreasonable to expect in practice. Therefore, soil scientists have been developing different soils with well-graded particle size distribution that help mitigate the effects of compaction while retaining moisture and nutrients. One method is by developing sandy loam or loamy sand soil which exhibits a small degree of compaction due to the angular shape of the particles that permit numerous points of contact creating structural stability. Soil texture and the effects on soil moisture depend on the particle size class being used (sand, silt, or clay) and their respective ratio in the mixture with the estimated available moisture content sitting between 7 percent and 11 percent. Another method being used involves using crushed stone to provide support and allow for drainage. The crushed stone also promotes rapid root exploration and growth.

### Permeable Surfaces

Surface-based infrastructure in the way of sidewalks and streets is vital to consider when addressing soil health in urban environments. One approach to ensure the availability of water, carbon dioxide, and oxygen to the tree roots is the use of pervious surfaces. This surface can also help reduce stormwater runoff by absorbing water, where it can be harvested or released into the drainage system.

Next is a drainage layer. This is a space installed between the surface and the soil, may also help promote root growth and tree stability. It is necessary to mention, however, that although permeable pavers can provide some benefits to roots, they still prevent the accumulation of organic material such as leaves and sticks. The lack of organic material could cause a challenge for mycorrhizal fungi who feed on organic matter. Therefore, soil conduits must be designed to allow organic matter to gather and decompose.

### Mycorrhizal Inoculation

Another important requirement is to inoculate the soil with healthy mycorrhizal communities. We also incorporate mycorrhizal fungi growth in these root paths that help connect the trees to each other. Mycorrhizal inoculation allows the urban trees to be more drought tolerant. The mycorrhizal root system is linked to increase water uptake. In a controlled study on soybeans and corn, researchers concluded that the inoculum formulation must be specifically tailored to each plant. In addition to promoting the healthy development of plants and providing them with nutrients, fungi also increase a plant's resilience against diseases. Reports have suggested that inoculating trees with fungal endophytes induces a plant's defense system, helping protect them from fungal pathogens (Arnold et al. 2003).

Urban introduced a protocol in 1992, that proposes standards for the design of planting sites as well as modifications to the landscape. These protocols are designed to help determine how much site modification is necessary for a tree to grow successfully. He breaks these into steps beginning with “determining soil quality,” then “determining level of urbanization,” and finally “find [ing] the site's minimum design criteria.” (Urban 1992). However, Urban's techniques are not related to optimizing the growth and health of mycorrhizae fungi, as the current invention does.

The soil conduit adapts the design of a root path to the specific needs of mycorrhizal fungi. The first change was to make the soil conduit open to the air, unlike prior art designs, which had paving laid over top. The main reason for this is to allow oxygen to penetrate the soil and increase aerobic activity within the rhizosphere. It also allows for other gases to permeate the soil, such as Carbon Dioxide.

Organic mulch is added on top of horticultural soil, followed by the addition of a metal grate that covers the soil conduit, allowing for air circulation as well as pedestrian traffic.

### Species Selection in Promoting Resilience and Connectivity

An informed approach to tree species selection in urban environments is imperative to protect, expand, build, and maintain urban forests. The fate of the urban tree may depend on the adaptability of plants to current and future climate change trends. Climate analogs and vulnerability metrics are currently being used to help guide species selection by identifying resilient species specific to a set of climatic conditions. As climate changes and temperatures increase, a shift in climate zones will occur, which will modify the boundaries of existing zones, making it more difficult for certain species of trees to survive. Therefore, it is necessary to understand these shifts in climate zones to evaluate how they will impact tree species in urban environments.

Pests and diseases also play a role in the selection of plant species with research suggesting that if a species dominates a particular canopy, its risk of infestation is increased compared to a canopy that contains diverse species. Examples of this are the Dutch elm disease (DED) or the emerald ash borer (EAB). To help combat this, researchers have developed the Pest Vulnerability Matrix (PVM)—a system that enables arborists and urban foresters to assess the vulnerability of urban trees to help mitigate potential risks caused by pests and diseases.

Species selection can also have an impact on atmospheric carbon dioxide levels in a city. Researchers conducted a study that explored how different species, decomposition, energy conservation, and maintenance scenarios influenced the net carbon impact of urban forests and their management. They discovered that planting long-living, low-maintenance and moderate to fast-growing species that are specific to site conditions had the largest impact on atmospheric carbon dioxide levels. Plants are also being selected based on their resistance to drought.

A study on a range of tree species was conducted to evaluate the leaf water potential at turgor loss to understand a plant's capacity to grow in dry and warm urban environments.

There are numerous reasons why species selection is of great importance when choosing species for an urban forest, however, another reason could also be added to this collection-tree connectivity. By categorizing and selecting tree species based on mycorrhizal compatibility, we believe that a novel approach could be developed that would favor trees that could form networks that transmit nutrients between trees.

The main components in the design of a soil conduit include:
1) a Grate, which may be metal,
2) Organic Mulch,
3) Fabric Filter Lining,
4) Horticultural Soil, and
5) Crushed Stone

FIG. 1 is a perspective view of several soil conduits 100 used for increasing the health of an urban forest according to one embodiment of the current invention. In this view the soil conduits 100 extend outward from a tree 10 in an urban setting allowing room for root growth. Preferably, there is an open base 17 under tree 10. The open base allows the flow of fluids and gases to and from the roots. The open base 17 may be filled with mulch 103.

### Organic Mulch

Mulching has been used since ancient times to minimize moisture loss and weed population as well as to enhance crop yield. Mulches can be organic or synthetic; however, for the purpose of this design, organic mulches consisting of plant and animal residue will be used, due to their ability to provide nutrients to the organisms (such as fungi) in the soil. The most commonly used materials for organic mulch include straw, husks, grass and cover crops, saw dust, compost and manure. Mulching helps regulate soil temperature with studies that suggest that mulch could keep the soil cool during hot climatic occurrences or absorb solar radiation to create heat when it is cold. There are also potential advantages of mulching as an effective method of removing heavy metals such as cadmium from the soil. Finally, mulch has been proven effective in diminishing the growth of weeds with a study that found a 92 percent decrease in weed production by creating a barrier that prevents light from germinating the small seeds. To ensure maximum effectiveness, the mulch used in the installation and upkeep of the soil conduit should not only be sourced from local organic debris but specifically from areas near plants associated with a compatible mycorrhizal type (which we cover in detail in the “Planting Scheme” below). Finally, mulch should be added at the beginning as well as throughout the growing season to replace what might get washed away by water.

FIG. 4 is an elevational, partial cross-sectional view perpendicular to the length of the elongated soil conduits used for increasing the health of an urban forest according to one embodiment of the current invention.

In FIGS. 1 and 4, tree 10 is shown with branches and leaves (the “canopy” 3). A trunk 4 connects the canopy 3 to a truncated root package, or root ball (16 of FIG. 4, which makes transplantation possible. Many urban trees are found in rural areas or grown in nurseries, then transplanted in urban areas. A machine typically scoops out a portion of the roots and packages the extracted roots with a fabric that holds the soil and moisture until the tree is planted in a different location. This is referred to as a root ball 16 and typically has only the proximal portion of the roots to make it easy to transport and plant.

Tree ball 16 is planted in a tree pit (2 of FIG. 4) in an urban setting.

In FIG. 1, two soil conduits 100 are shown in a cross section. They extend out in the direction of the page. These soil conduits 100 allow for the roots 5 of FIGS. 4-6 of tree 10 to grow along the conduits 100 to communicate with the roots of other trees 10.

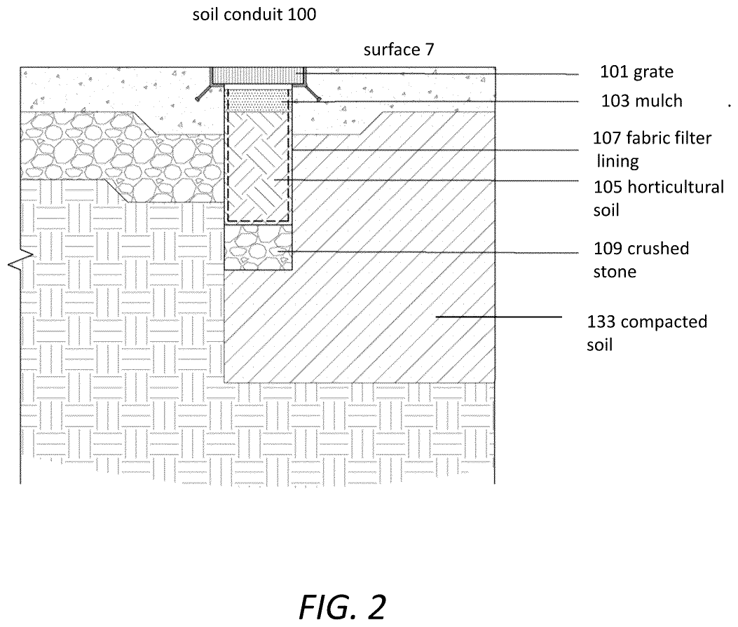

FIG. 2 is an enlarged view of one of the soil conduits of FIG. 1. The soil conduits will be further described in connection with FIGS. 2-6.

### Grates

A grate 101 anchored into the concrete sits securely on the top of the soil conduit 100, protecting it from soil compaction and debris while allowing water and nutrients to pass through. Grate 101 should be attached in a way that can be removed in order to top up the mulch or clean out any debris that has collected in the space below it. The size of the openings (or negative space) in the grate 101 must be selected based on the overall engineering of the site to ensure favorable hydraulic conditions for the roots and associated mycorrhizae. Studies investigating the impact of the grated geometry on the flow rate of stormwater have found that hydraulic efficiency could be linked to the void ratio within the grated configuration. The void ratio must also be considered when screening out larger pieces of debris in favor of smaller pieces of organic material. Safety has become another consideration when designing grates for soil conduits. Grates designed with diagonal geometric patterns and that lie perpendicular to the curb line are safer for cyclists.

As indicated above, pavement and sidewalks restrict the flow of water down to the roots under the pavement. Therefore, the current design employs grates 101 in place of pavement or sidewalks on the ground surface 15. This allows the free flow of not only water but other liquids to the roots. These other liquids may be nutrients dissolved in water.

Also, engineered soil directly increases the health of urban trees. The soil must retain enough water and nutrients to allow healthy growth but must not get too much water to cause diseases of the roots.

### Crushed Stone

Therefore, crushed stone 109 is employed at the bottom of the soil conduits 100. The crushed stone allows for drainage.

With a push to increase stormwater control measures (SCMs) in cities, researchers have been exploring using tree pits as a method of controlling and filtering water while also increasing tree growth. Tree pits can either have underground drainage through piping or rely on filtration into the surrounding soil as the main way of dispersing stormwater. This drainage layer, such as crushed stone layer 109 in the soil conduit is essential for filtering and dissipating stormwater runoff to prevent the tree roots and associated microorganisms from becoming waterlogged. Another benefit of using a crushed stone layer 109 is that it helps filter and reduce pollutants and sediments that can be found in stormwater runoff. Led by the guiding principles of sustainable drainage systems (SUDs) that dictate that the drainage should be a near-replica of the site before it was developed, the depth of the stone layer and the size of the stones are dependent on the location. For example, a study in Ireland discussed a variety of stones used in a selection of sites to create the ideal drainage and filtration rate required.

Soil conduits 100 should also create an environment in which both the tree roots, 5 and the mycorrhizal fungus can thrive. Horticultural soil 105 works well for this function. It is usually loose and allows filtration of water and other fluids. It is separated from the crushed stone with filter fabric 107.

### Filter Fabric

Considered a geotextile, the filter fabric lining 107 acts as a separator between the soil conduit 100 and neighboring layers of urban fill, such as compacted structural soil 133. Geotextiles can be categorized into three groups according to CEN, the European Committee for Standardization, an association that brings together the National Standardization Bodies of thirty-four European countries. The first is a woven textile produced by interlacing two sets of yarn, filaments or other material on a loom; the second is a knitted geotextile produced by interloping one or more sets of yarn, filament or other materials on a knitting machine; and the third is a nonwoven geotextile produced with directionally or randomly oriented fibers, filaments or other elements by needle-punching, bonding with partial melting or chemical binding agents. Since geotextiles can perform different functions, it is of great importance to select the type best suited to the needs of the design. The role of this geotextile in the context of the soil conduit is to retain soil and let water through. A nonwoven filter fabric is recommended to separate the layers of soils from urban fill as well as to allow for water drainage. A selection of different natural and synthetic fibers are used in the production of geotextiles. Natural fibers consist of plant, animal and mineral origin, offering a high strength, high modulus, low breaking extension and low elasticity. Mineral fibers are brittle and far less strong and flexible. Synthetic fibers, also known as geosynthetics, are the main components present in all geotextiles and can be categorized in the following groups: polypropylene, polyester, polyamide and polyethylene. There are advantages and disadvantages to all geotextiles; therefore, the choice depends on site conditions and envisaged application. Due to their compositional ability to degrade in the soil, natural fibers should be avoided when installing a soil conduit, in favor of geosynthetics, which can resist degradative conditions and offer increased stability.

### Horticultural Soil

Selecting the appropriate medium (horticultural soil 105) in which roots grow, and microorganisms interact is of paramount importance in the design of the soil conduit 100, since poor soil quality is the leading cause of tree stress in urban environments (Scharenbroch et al. 2014). In many cases where the local soil is not adequate, engineered urban soils (EUS) are designed to meet the requirements of the site. These EUSs are divided into two categories: horticultural mixes (HM) and structural soils. Made of a blend of organic materials, a mineral soil base and sometimes fertilizers, horticultural soil 105 is used for growing plants and mitigating stormwater runoff rather than to support load-bearing infrastructure. Studies on HM soil quality in Boston MA indicate sandy loams with pH between 6 and 7 and 5 percent of organic matter favorable for tree growth. But due to fluctuation in climatic conditions, a unique HM blend must be designed for each site.

The horticultural soil 105 is thoroughly inoculated with mycorrhizal fungi. Finally, a layer of mulch 103 is spread on top of the horticultural soil 105.

In the embodiments shown in FIGS. 1-6 and 11, the soil conduits 100 are typically 14 inches deep and 4″ wide. The grates are 2 inches deep, the mulch 103 is also 2 inches deep. Horticultural soil 105 is 10 inches deep, and the crushed stone 109 is 4 inches deep.

### Crushed Stone

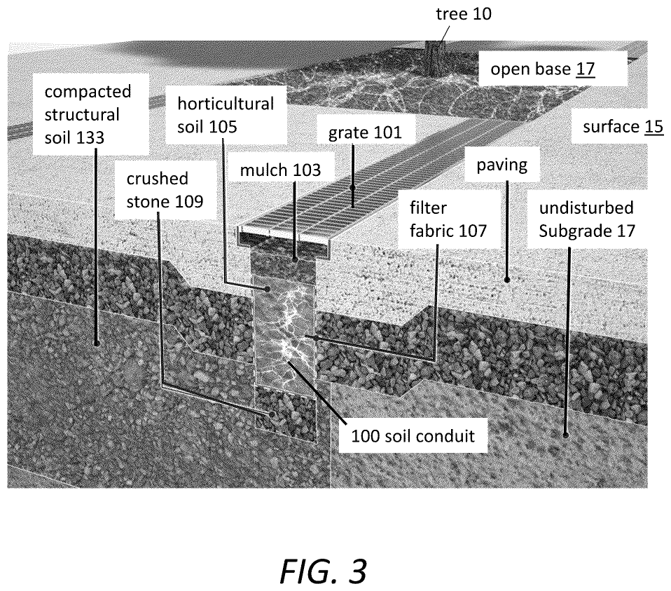

FIG. 3 is a perspective view of another embodiment of a soil conduit according to the present invention. It shows many of the same structures disclosed in FIGS. 1-2, 4 and 6. Here tree 10 extends out of an open base 17. A soil conduit 100 extends outward away from the open base 17. The soil conduit has a grate 101 above mulch 103, horticultural soil 105 and crushed stone 109.

FIG. 4 is an elevational, partial cross-sectional view through the length of an elongated soil conduit features used for increasing the health of an urban forest according to one embodiment of the current invention.

In this view, grate 101 is visible, which has slots allowing fluids to flow downward toward the mulch layer 103 and to the roots 5. The slots also allow gases to freely pass through grate 101.

Tree 10 has a canopy 3 and trunk 4 that connects to the root ball 16. Roots 5 begin to grow out of root ball 16 and extending through the soil conduit 100. Most of the roots 5 grow in the horticultural soil 105 between the mulch layer 103 and the filter fabric 107 and interact with the mycorrhizal fungi. The crushed stone 109 below the filter fabric 107 drains off excess liquid.

This construction allows support for pedestrians or vehicles passing over it as required in an urban area.

It also is designed to receive moisture and nutrients from above through the grates 101.

The mulch holds organic material which can decompose and provide nutrients. These organic nutrients are allowed to seep downward toward the roots 5 in the soil conduits 100.

The mulch 103 and horticultural soil 105 retain moisture for the trees 10, and for the microbes and fungus networks grow and thrive in the horticultural soil around and between the roots 5. This arrangement helps to develop the fungal network.

The fungal networks function to digest organic material and create nutrients. The fungal network passes these nutrients between roots 5 of the same tree or of roots 5 between different trees. This nutrient communication is believed to cause trees to be more resilient and healthier overall.

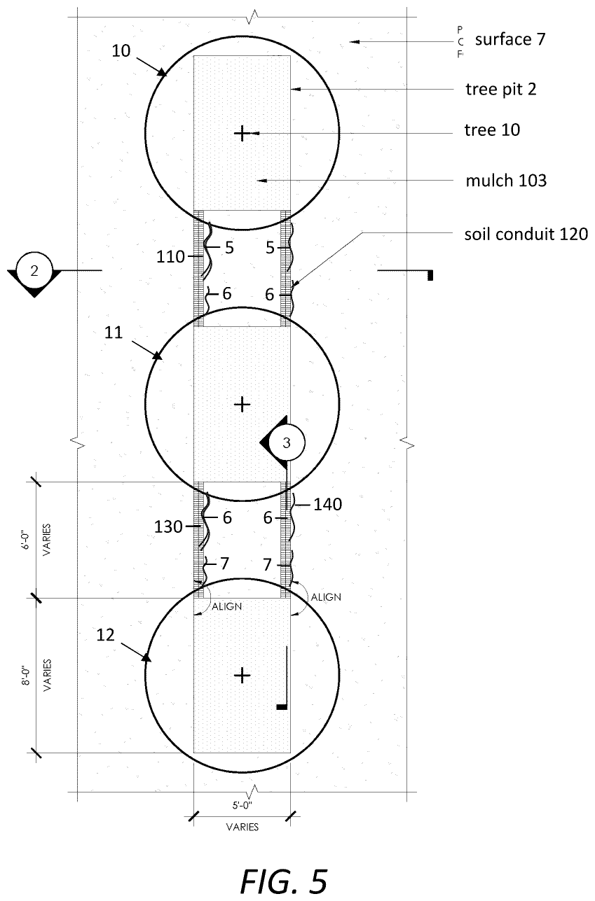

FIG. 5 is a plan view showing two conduits 110, 120 between trees 10, 11, and soil conduits 130, 140 between trees 11 and 12. Roots 5 from tree 10 extend through conduits 110 and 120. Roots 6 from tree 11 grow and extend through conduits 110 and 120 in the direction of roots 5 of tree 10. In one case, roots 5 and 6 may come close enough to directly exchange nutrients. In an alternative arrangement, fungus and fungus networks grow around and between the roots 5 and 6. The fungus facilitates nutrient transfer between the fungus network and roots 5 and 6.

Similarly, soil conduits 130 and 140 are designed to extend between the roots 6 of tree 11 and roots 7 of tree 12. Conduits 130 and 140 have similar structures to that described in the previous figures.

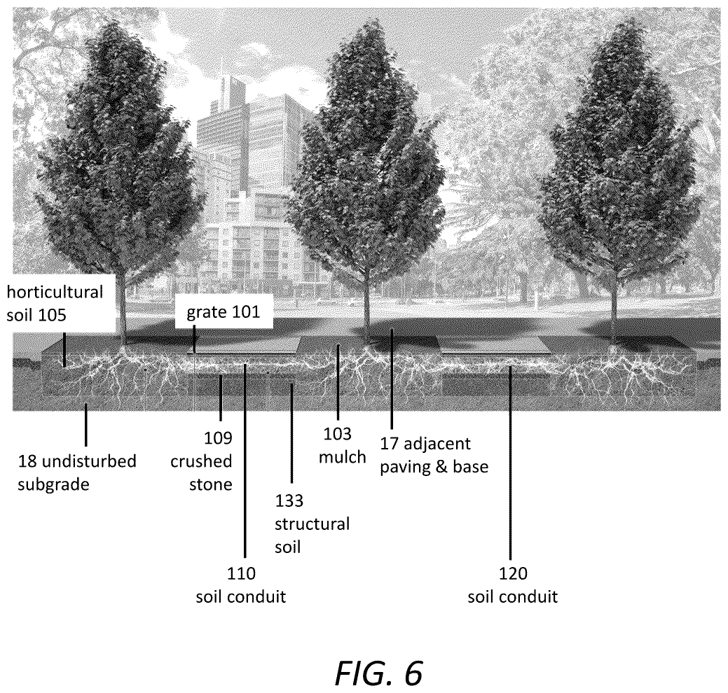

FIG. 6 is a side elevational view of a partially cut-away drawing of three trees arranged in a line connected by soil conduits 110, 120, 130, and 140. Even though three trees are shown here, any number of trees and conduits may be used in various patterns such as star patterns in which soil conduits form several trees meet at a common location.

There can be any number of conduits extending from and to each tree. These do not have to be parallel, but can be arranged in any fashion, such as radiating out from a tree. The soil conduits do not have to be straight but can have any number of curves. The soil conduits can also curve deeper or toward the surface, as long as they extend to other tree roots, or soil conduits.

### Planting Scheme

This planting scheme builds on existing knowledge of landscape ecology by suggesting that mycorrhizal interactions with plants should also be considered when designing landscapes in urban environments. Landscape ecology plays a significant role when understanding how biodiversity responds to environmental change, which focuses on land-use, habitat fragmentation and scaling. Studies have shown that a city's biodiversity represents a selection of the species pool of the greater area or region. As regional biodiversity increases, cities trend towards decreasing the proportion of the regional species pool (Ferenc et al. 2013). A city's climate zone can also have a significant effect on how biodiversity responds to the urban environment. This has led to the habitat-matching hypothesis, that native species or species from a similar habitat adapt better to an urban environment in the same climatic region. The patch-matrix concept aims to create large patches of green spaces to increase species richness in cities. Connectivity between these patches, however, relies greatly on patch proximity to another one, the ability of the relevant species to disperse as well as the “quality” of the species matrix. Adjacent urban density to a green patch also plays an important role, because it can lower the species richness of a habitat.

Led by the principles presented in the patch-matrix concept and the habitat-matching hypothesis, combined with a focus on species interaction, recommendations for species selection is informed by a series of libraries that list plant species in accordance with their mycorrhizal type, focusing primarily on two types-arbuscular mycorrhizae (AM) (also known as endomycorrhizae), and ectomycorrhizae (ECM). From a scientific database to a practice-based website, these resources are freely available online. We highlight three of these resources. The first of the three fungus publications is MycoDB, an impressive database containing 4,010 studies (from 438 unique publications) aimed at facilitating a meta-analysis of the interactions between mycorrhizal fungi and plant productivity. Thousands of plant species have been associated with specific mycorrhizal types.

The second is an extensive list of commonly used landscaping plants associated with their compatible mycorrhizal fungi for the purpose of the designed inoculants for commercial applications (Mycorrhizal Applications 2020).

Third is the New Phytologist publication of “A Check-List of Mycorrhiza in the British Flora” by J. L. Harley and E. L Harley (1987), comprises an extensive library of plants used in British gardening paired with their compatible mycorrhizal types.

For more information on the role of fungi in urban settings, please refer to Newbound, M., Mccarthy, M. A., Lebel, T., 2010. Fungi and the urban environment: A review. Landscape Urban Plan. 96, 138-145. https://doi.org/10.1016/j.landurbplan.2010.04.005.

Studies have shown that forest trees who associate with the same mycorrhizal type, such as ectomycorrhizal, could transmit nutrients to each other Beiler, K. J., Durall, D. M., Simard, S. W., Maxwell, S. A., Kretzer, A. M., 2009. Architecture of the wood-wide web: Rhizopogon spp. genets link multiple Douglas-fir cohorts. New Phytol. 185, 543-553. https://doi.org/10.1111/j.1469-8137.2009.03069.x.

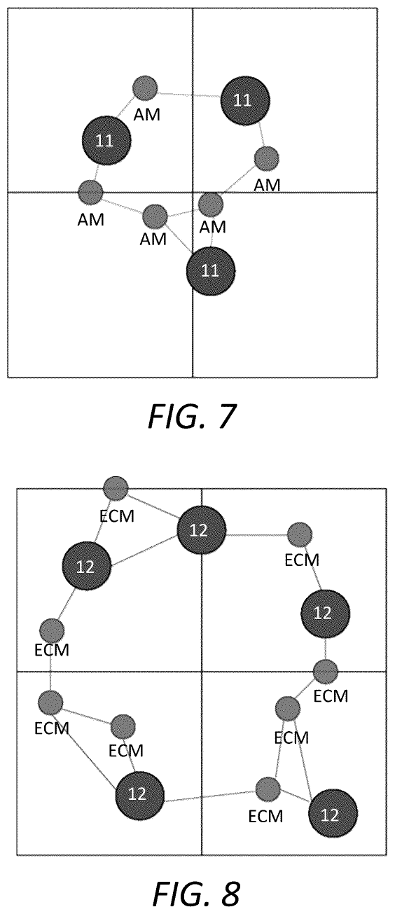

Based on this research, this planting scheme suggests that if we select plants that all associate to the same mycorrhizal type, a common mycorrhizal network (CMN) can be created in a green patch and travel to other patches through the soil conduit as shown in FIGS. 5 and 6. This planting scheme should steer clear of a monoculture by following the principles mentioned above regarding biodiversity and climatic relevance and should result in a rich selection of species resilient to the stresses of urbanization. An example of a mycorrhizal planting scheme could consist of an over story of AM-associated acer spp. and pyrus trees with an understory of smaller AM shrubs such as rubus or digitalis as illustrated in FIG. 7.

A different configuration could be added that includes only ectomycorrhizae ECM pairing of trees and shrubs, which could encourage the formation of a second CMN as shown in FIG. 8.

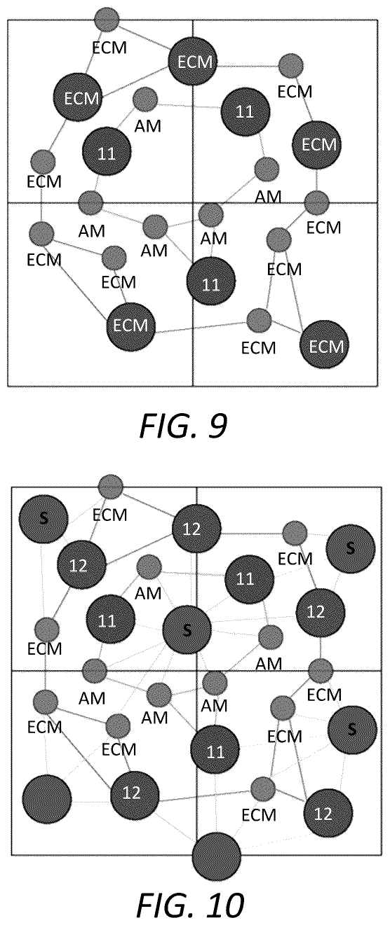

These CMNs may exist side by side as shown in FIG. 9, but not interact with each other.

It is important to note that some plants are associated with more than one type of mycorrhiza, such as salix(S), which could act as a bridge between ECM and AM plants if used in a planting scheme forming an even larger CMN as shown in FIG. 10.

### Experimental Design

The present invention has been expanded upon and tested through a rigorous experiment relating to connected soil conduits. An experiment was designed to prove that trees can indeed transmit nutrients in an artificially constructed channel, to increase the overall health of urban trees.

The experiment involves fifty-two oak trees erected in a greenhouse. This application details the methodologies and processes behind the set-up of this experiment. This experiment contributes to the field of urban ecology and landscape architecture.

Various implementations are being explored including trenching and channeling systems that will connect the urban rhizosphere and form corridors (soil conduits 100) such as the soil conduits 100 shown in the previous figures.

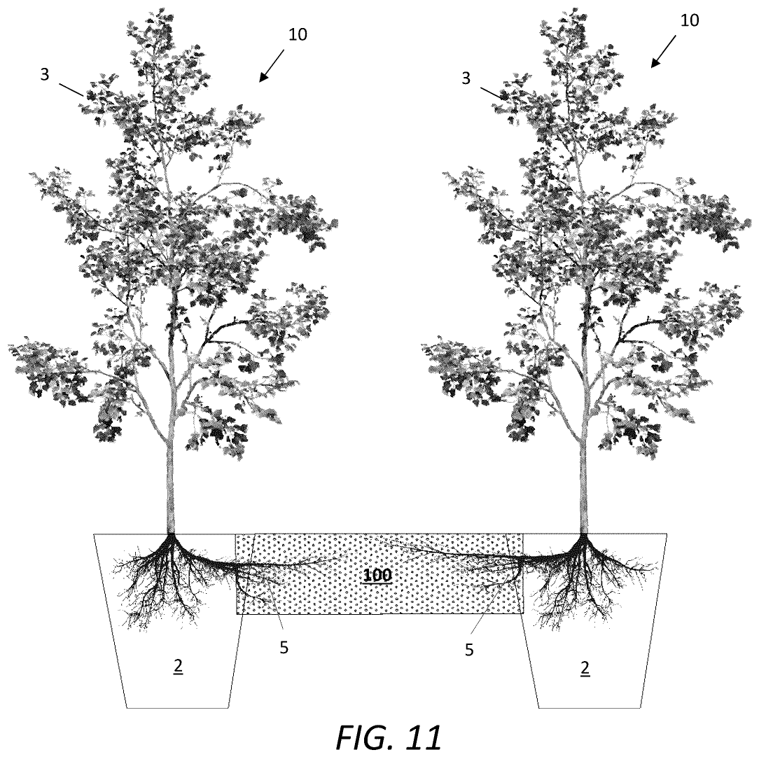

FIG. 11 is a schematic drawing demonstrating soil conduits linking one tree located in a tree pit to a neighboring tree that was the subject of the experimentation.

Soil volume is an important point to address with this research with soil compaction in the urban environment as one of many challenges that urban trees and their root systems must endure. Situated just below the surface of the ground, a soil conduit 100, in this example, a soil conduit 100 measures four inches wide by 12 inches high. The soil conduit 100 extrudes out from tree pit 2, which should include approximately 1,300 cubic feet.

This design of the current invention provides space for the root systems to grow and also has another equally important function. The soil conduits 100 also promote fungi growth, such as mycorrhizal fungi.

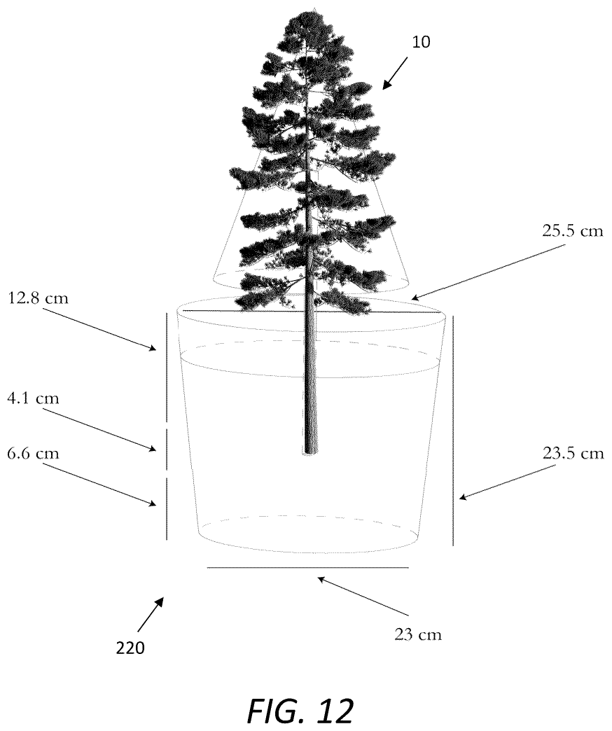

FIG. 12 shows the dimensions and depth of its contents of pots used in the experiments as controls. Each of the pots chosen for this experiment has open upper edges with a diameter of 25.5 cm., a bottom with a diameter of 23 cm., and a height of 23.5 cm.

The bottom 6.6 cm. is filled with crushed stone, the 4.1 cm. above this is filled with horticultural soil and the top 12.8 cm. is filled with mulch.

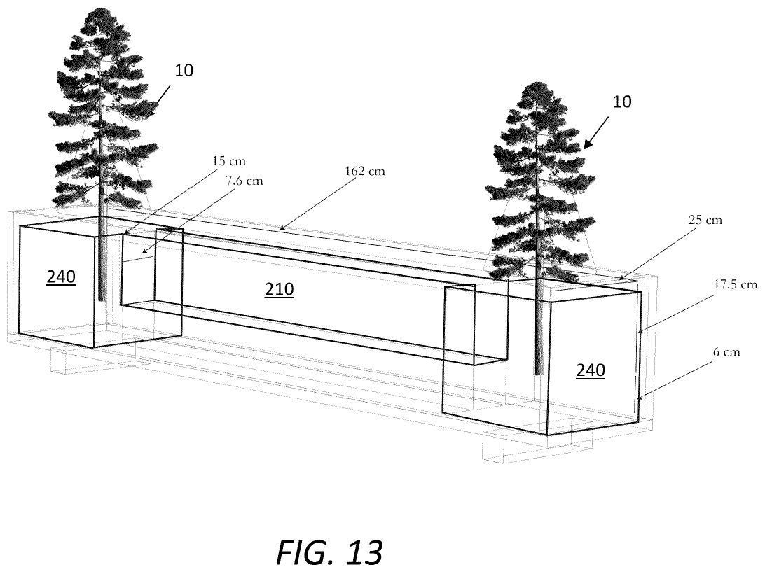

FIG. 13 is a diagram showing the dimensions of a wooden soil conduit 210 connecting two wooden boxes 240 used in the experiments. FIG. 13 shows the dimensions of wooden boxes 240 and a wooden conduit 210 connecting the wooden boxes 240 used to simulate the actual soil conduits. The dimensions may be varied to determine optimum dimensions.

The wooden boxes 240 were constructed to hold sample trees 10. The wooden soil conduit 210 was constructed to be 17.5 cm. high, 25 cm. wide and 162 cm. long that connects the wooden boxes 240. The wooden soil conduit 210 holds a plurality of sandbags in a region 15 cm. deep and 7.6 cm. wide. The wooden conduit 210 extends 162 cm. between the wooden boxes 240.

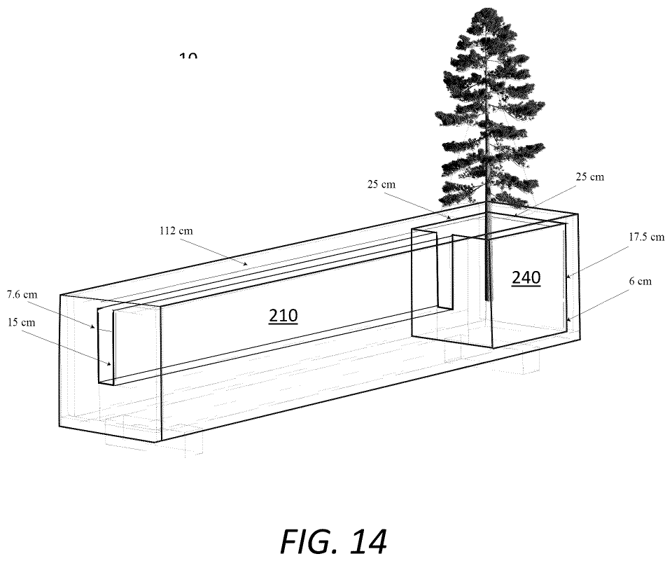

FIG. 14 is a diagram showing the dimensions of another wooden soil conduit 210 used in the experiments. This wooden soil conduit 210 is connected to a single wooden box 240 having dimensions of 25 cm. wide×25 cm. long by 23.5 cm. deep filled 17.5 cm. deep with soil. 6 cm. below the soil is a drainage material, such as crushed stone.

The wooden soil conduit 210 extends 112 cm. from an opening in a side of the wooden box 240. Soil Conduit 210 is filled with the same material as indicated in FIG. 13.

The experiment design employs three treatments, A.1, B.1 and C.1 used for the White Swamp Oak and the Pin Oak tree species. Table 1 indicates the type of soil conduit used and the number of trees involved. Replicates indicates the number of duplicate arrangements of each.

TABLE 1
A) White Swamp Oak

| # | Soin Conduit | Replicates | # of Trees |
|---|---|---|---|
| A.1 | Yes | 7 | 2 |
| B.1 | No (Control pot) | 7 | 1 |
| C.1 | Severed | 7 | 1 (+1 extra |
| | | | sacrificial) |
| | | 21 | 29 |

B) Pin Oak

| # | Soil Conduit | Replicates | # of Trees |
|---|---|---|---|
| A.2 | Yes | 7 | 2 |
| B.2 | No (Control Pot) | 3* | 1 |
| C.2 | Severed | 7 | 1 |
| | | 17 | 24 |

The experiment has been designed and set up in a greenhouse in the Harvard Forest in Petersham, MA, that will attempt to demonstrate that mycorrhizal fungi can connect two oak trees, as shown in FIG. 11. Soil conduits were simulated using wood (“wooden soil conduits 210”) to simulate a soil conduit 100 in an urban setting. Twenty-nine White Swamp Oaks (Quercus bicolor), and twenty-four Pin Oaks (Quercus palustris) were acquired to test three treatments as indicated above in Table 1. Treatments A.1 and A.2 with two trees that shared a soil conduit 100 at either end.

The second treatment, B.1 and B.2, included one tree and a soil conduit 100 to nowhere.

The third treatment included a control pot that had no soil conduits. In the third treatment, C1 and C2, are intended to simulate a tree 10 in a tree pit 2 that is shared with a postdoctoral researcher, Chikae Tatsumi, from Boston University, who is researching urban soil composition. The wooden conduits were scaled down from standard tree planting specifications to include 12-inch-tall saplings rather than full-grown trees. Pots were used instead of tree pits 2.

As the experiment progressed, tree health will be monitored through standard observational assessment techniques such as caliper size and tree height. To measure mycorrhizal growth in the wooden conduits 210 of each experimental unit we used the “Ingrowth Ectomycorrhizal Hyphae in Mesh Bags” protocol developed by Mark Bakker in 2009. This protocol sees bags filled with sand, placed in a 6-inch hole in the soil conduit 100, that captures mycorrhizal hyphae as the root structure growing through the wooden conduits 210. The sand that filled the mesh bags was first washed with 38% or 12N concentrated hydrochloric acid using an acid washing protocol used to reduce the background ergosterol and PLFA signal attributed to saprotrophic fungi′. Bags are then retrieved at specific increments and analyzed for evidence of mycorrhizal colonization.

### Time-Line

(May 16, 2023-May 18, 2023) 280 mesh bags were fabricated, and the sand was washed using hydrochloric acid using the protocol mentioned above combined with one developed by Dr. Estefania Fernandez.

(May 18, 2023) 53 trees were delivered in addition to two cubic yards of Loam (horticultural soil) and one cubic yard of Ricestone (crushed stone) to the site (Harvard Forest).

(May 19, 2023) 29 wooden conduits 210 and tools that were designed to facilitate assembly were fabricated by local carpenters and delivered to the site. The soil conduits 100 (conduits) as shown in FIG. 13, were built using ¾ plywood, lined with a plastic liner, and included numerous drill holes in the bottom to facilitate drainage.

Approximately three cubic feet of oak-dominated forest soil in Harvard Forest was collected to inoculate specific trees in the experiment. This forest is part of the Urban New England (UNE) project, run by Lucy Hutyra and Pam Templer at Boston University. We sampled soil in six different locations within a 15 m×15 m area on the interior of HF06 (UNE site ID, 42.479870, −72.178410), located off Barre Road. The top 10 cm of soil (only the organic horizon), including roots, was collected using shovels and placed into coolers. Soil was collected only underneath mature oak trees, enabling us to target oak-associated to ectomycorrhizae ECM fungi and their associated microbiomes.

Lines were marked on the wooden conduits 210 with a marker to indicate how high each of the soil types should be filled. Lines were also marked on the side of the wooden conduits 210 marked at locations to indicate the locations to place the mesh bags.

(May 21, 2023-May 23, 2023) 7 Experimental blocks were created to organize both Vanessa Harden and Chikae Tatsumi's experiments that are in the greenhouses.

All pots were filled at the 25% mark (6.35 cm from the bottom) with a layer of Palmetto Small Grain Vermiculite. conduits in Blocks 1, 4, 5, 6, 7 also used Palmetto Small Grain Vermiculite, whereas Blocks 2 and 3 used New Grain Whittemore Vermiculite (because we ran out of the previous brand).

Once the pots were filled with vermiculite, the urban soil was mixed at a ratio of 87.5% Loam with 12.5% ¼ Ricestone in a wheelbarrow and shoveled into the pots.

Scharenbroch et al. (2017), in the appendix indicates that the soil texture common in streets in Boston is “S, SI, C; CF=50-75%” or “SL, SIL, L; CF<25%.”

*Abbreviations for the texture classes are HC, heavy clay; C, clay; SiC, silty clay; SiCL, silty clay loam; CL, clay loam; SC, sandy clay; SiL, silt loam; L, loam; SCL, sandy clay loam; SL, sandy loam; Si, silt; LS, loamy sand; S, sand. CF, coarse fragments (>2 mm).

We made sure to use shovels and buckets disinfected with 95% ethanol to avoid contaminating the “urban mix” with potential fungi from the inoculum or our hands. In addition, sterile gloves were used to handle this mix. We also made sure to wear separate pairs of gloves to handle the forest soil inoculum and the urban mix. This was because we assumed that the urban mix was nearly sterile, and we did not want to introduce potential mycorrhiza present in the inoculum.

The wooden conduits 210 were filled at the 25% mark with Vermiculite. A tool was then placed into the conduit to create positive space while the surrounding space on either side was filled with the urban soil mix and compacted (to replicate existing urban conditions).

Inoculant is then placed (2 cm high) on one side of the wooden conduits 210 (where the tree will be planted) using gloves to ensure it does not contaminate anywhere else in the wooden conduits 210. The tree saplings are placed in “tree pit” 2 at either end of the large wooden conduits 210 (pin oak with pin oak and same for white oak) and at one end of the small soil conduit. We made sure to spread the inoculum around the tree ball 3, to make sure the plant's roots were in contact with the forest soil. The tree pit 2 was then filled with loose urban soil.

The tool is then removed to reveal a channel in the compacted soil that can also be filled with loose urban soil. This process is then repeated for each wooden box 210.

While wearing gloves, 50 ml of the acid-washed sand is funneled into each bag (approximately 10 cm deep) and closed off using a cable tie. Each bag is then tagged with flagging tape and marked with a number (1-280) to identify the bags. The blue tape corresponds to the Pin Oak, and the orange tape corresponds to the White Oak. 10 bags are then placed in each wooden conduit 210 in pairs at 20-23 cm increments marked on the edges, with one bag in the center of the channel and the other next to it in the compacted soil. The bags are placed in a 15 cm hole made by a metal rod. A sand-filled mesh bag is inserted into the hole in the soil conduit. All trees were watered after planting to avoid desiccation and the tree dying off after transplanting.

Referencing the Boston Street tree protocol that was obtained through a tree warden, 42 ml of Drench, a mix of fertilizers commonly used by urban tree wardens to offer initial support to the sapling, is added to each pot and wooden conduits 210.

To make 2.5 gallons of drench, mix:
Essential Plus 1-0-1 (2 quarts/100 gal=0.5 gal/100 gal=00125 gal/2.5 gal)
DKP XTRA Feb. 20, 2022 (2 quarts/100 gal=0.5 gal/100 gal=0.0125 gal/2.5 gal)
Hydro-Max Wetting Agent (1 gal/100 gal=0.025 gal/2.5 gal)

All trees are watered, and a GoPro camera is set up to record the progress.

(Jun. 10, 2023) After waiting for 1 month to allow for trees to acclimate to the transplant and new growing conditions, measurements of tree diameter and height were taken. Dead leaves and branches were removed to ensure that no dead branches were adding height to the measurements. The height was measured from the baseline to the top of each sapling. The baseline was defined as 0.5 inches lower than the top of the pot and the diameter was measured at the top of the pot.

### Learning Outcomes

Although this experiment has only just been established with the intent of continuing till December 2024, findings about what course of care should be followed or what protocol should be used in the lab are now being addressed. This report was written in September of 2023, four months after the experiment has been set up. Various challenges have arisen that have seen the experimental method shifting and adapting to the current circumstances. As the first formal experiment that I undertake, I am continuously being challenged to learn basic experimental processes while generating data that is both reliable and publishable.

### Watering Cadence

In trying to mimic watering conditions in urban Boston while also ensuring that the saplings are establishing themselves and growing has been a challenge. At first, we were watering 0.35 inches every 3 days in accordance with the Boston precipitation records with 42 inches of annual rainfall shown in Table 2.

TABLE 2
NOWData - NOAA Online Weather Data [symbol] [symbol] [symbol]
Monthly Total Precipitation for Boston Area, MA (ThreadEx)
Click column heading to sort ascending, click again to sort descending.

| Year | January | February | March | April | May | June | July | August | September | October | November | December | Annual |
|---|---|---|---|---|---|---|---|---|---|---|---|---|---|
| 2012 | 2.67 | 1.00 | 1.21 | 3.09 | 3.43 | 4.71 | [symbol] | 3.08 | 4.10 | 2.62 | 1.01 | 5.93 | 36.73 |
| 2013 | 1.08 | 5.26 | 3.32 | 1.37 | 3.22 | 10.50 | 3.61 | 1.84 | 2.21 | 0.61 | 2.72 | 4.62 | 40.36 |
| 2014 | 3.24 | 4.13 | 4.48 | 3.24 | 2.86 | [symbol] | 4.57 | 1.75 | 0.70 | 5.83 | 5.27 | 6.56 | 45.25 |
| 2015 | 3.57 | 3.37 | 3.05 | 2.28 | 1.22 | 5.01 | 2.09 | 2.19 | 3.93 | 1.74 | 2.07 | 4.2 [symbol] | 34.80 |
| 2016 | 3.27 | 4.17 | 3.16 | 2.91 | 2.83 | 1.33 | [symbol] | 1.72 | 1.38 | 5.46 | 2.70 | 3.25 | 33.05 |
| 2017 | 4.25 | 3.22 | 4.18 | 5.73 | 3.45 | 4.85 | 4.03 | 1.58 | 3.73 | 4.14 | 1.80 | 2.49 | 43.45 |
| 2018 | 4.92 | 3.77 | 5.07 | 4.62 | 1.90 | 2.96 | 4.55 | 4.65 | 5.12 | 3.78 | 9.26 | 2.72 | 53.32 |
| 2019 | 3.62 | 3.45 | 2.95 | 6.52 | 3.35 | 5.15 | [symbol] | 3.48 | 2.16 | 4.45 | 3.37 | 6.07 | 50.38 |
| 2020 | 1.39 | 3.30 | 3.60 | 4.33 | 2.21 | 2.6 [symbol] | 1.95 | 2.28 | 0.97 | 4.9 [symbol] | 4.20 | 5.67 | 37.54 |
| 2021 | 2.02 | 3.05 | 1.89 | 4.44 | 4.92 | 2.57 | 10.07 | 7.00 | 7.47 | 5.11 | 1.34 | 2.45 | 52.33 |
| 2022 | 2.33 | 4.61 | 2.93 | 2.32 | 1.32 | 2.33 | 0.62 | 1.47 | 2.60 | 4.2 [symbol] | 2.69 | 3.75 | 31.25 |
| Mean | 2.94 | 3.58 | 3.26 | 3.71 | 2.79 | 4.06 | 3.82 | 2.82 | 3.12 | 3.91 | 3.31 | 4.34 | 41.68 |
| Max | 4.92 | 5.26 | 5.07 | 6.52 | 4.92 | 10.50 | 10.07 | 7.00 | 7.47 | 5.83 | 9.26 | 6.56 | 53.32 |
| | 2018 | 2013 | 2018 | 2019 | 2021 | 2013 | 2021 | 2021 | 2021 | 2014 | 2018 | 2014 | 2018 |
| Min | 1.08 | 1.00 | 1.21 | 1.37 | 1.22 | 1.33 | 0.62 | 1.47 | 0.70 | 0.61 | 1.01 | 2.45 | 31.25 |
| | 2013 | 2012 | 2012 | 2013 | 2015 | 2016 | 2022 | 2022 | 2014 | 2013 | 2012 | 2021 | 2022 |

[symbol]

indicates data missing or illegible when filed

After a few weeks, however, we noticed that the leaves on the trees were wilting. Assuming that these conditions were too harsh for saplings, we changed the schedule to a more frequent watering schedule. This seemed to solve the problem until the leaves began rusting slightly and turning dark green. With a more frequent watering schedule, the saplings were being overwatered. The schedule has been changed back to the original every three days, but the soil in the bottom of the pot was still too saturated with water. With October nearing and the temperature getting colder, we have now set the watering to every four days. Although this may be the correct amount of water for the moment, this will inevitably chase with as the outside temperature changes and moves through the seasons. Therefore, water calibration will continue to be one of the important variables that will need to remain dynamic and evolve with the outdoor climatic conditions.

### Hyphal Mesh Bags

The hyphal mesh bags will be colonized by mycorrhizal fungi over the course of the experiment, producing the data to support that soil conduits can facilitate tree connectivity. Each bag was made using a nylon mesh (50 microns) and sealed using a plastic bag sealer and closed off using a plastic cable tie.

Twenty-eight wooden conduits 210, each acting as a soil conduit, held 10 mesh bags each—one in the loose soil of the conduit and one in the compacted soil next to it to be able to compare the effects of soil compaction on colonization. In total, 280 mesh bags measuring approx. 5 cm×15 cm were created. They were each filled with 50 ml of acid-washed sand and placed in a 15 cm. deep hole in the loose soiled channel and the compacted soil at 25 cm. increments. The plan is to retrieve two from each wooden b, every four months for twenty months. To ensure that the bags have been colonized, the seventh block in the experiment has been designated the sacrificial experimental units to be able to test as well as practice the bag analysis protocol in addition to verifying that mycorrhizal fungi have colonized the bags. Eight hyphal mesh bags were collected from the sacrificial conduits from the seventh bench to be analyzed in the laboratory. The bags were tagged, placed in separate plastic bags, and brought back to the lab in a cooler where they were placed in the fridge at 40 C. The bags are waiting to be examined to determine if they have been colonized by mycorrhizal fungi. If they have, we will be able to begin harvesting before the official experiment. If they are not colonized, then we will wait 2-3 months before harvesting another sacrificial bag and/or analyzing the soil nearest to the inoculated tree for mycorrhizal colonization and assess next steps from there.

With 68% of trees showing positive growth, we now need to understand what is happening with the 28% that are showing signs of decline. By continuing to record various health parameters in collaboration with Dr. Chikae Tatsumi, from Boston University, we will be able to begin to see trends in the data that will hopefully lead us to understand the efficacy of artificially created channels and if they, in fact, do help facilitate mycorrhizal connectivity between plants.

The design of infrastructure in urban environments should support mycorrhizal networks as a fundamental factor in soil health and overall tree development. There is strong connection between healthy soil, mycorrhizal fungi and tree mortality. A network of soil conduits should be incorporated into the urban environment to connect tree pits, to decrease the tree mortality rates in our cities.

Although the present invention has been illustrated and described herein with reference to preferred embodiments and specific examples, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the claims of this application.

What is claimed is:

1. A method of creating more resilient urban forests comprising the steps of:
a. digging a tree pit, for a plurality of trees;
b. planting a root ball of a tree in the tree pit;
c. digging a plurality of soil conduits extending from the root ball toward: root systems of other urban trees,
d. inoculating soil with mycorrhizal fungi; and
e. at least partially filling the soil conduits with the inoculated soil.

2. The method of claim 1 further comprising the step of:
covering at least a portion of one of the soil conduits with a fluid permeable rigid surface.

3. The method of claim 1 further comprising the step of:
applying a layer of mulch above the inoculated soil in at least one soil conduit.

4. The method of claim 1 further comprising the step of:
applying a layer of crushed stone below the inoculated soil in at least one soil conduit.

5. The method of claim 1 further comprising the step of:
applying a filter fabric mesh between the crushed stone below the inoculated soil in at least one soil conduit.

6. The method of claim 1 wherein the step of at least partially filling the soil conduits 100 with the inoculated soil comprises the step of:
at least partially filling the soil conduits with the inoculated horticultural soil.

7. The method of claim 1 wherein the step of digging a plurality of soil conduits includes digging a plurality of soil conduits extending from the root ball toward other soil conduits.

8. The method of claim 1 further requiring, before the step of planting a root ball of a tree in the tree pit, the steps of:
a. determining a species of tree that is best suited for an average temperature of a location selected to plant the urban forest; and
b. planting the determined species of tree.

9. The method of claim 1 further requiring, before the step of planting a root ball of a tree in the tree pit, the steps of:
a. determining a species of tree that is best suited for an average rainfall of a location selected to plant the urban forest; and
b. planting the determined species of tree.

10. The method of claim 1 further requiring, before the step of planting a root ball of a tree in the tree pit, the steps of:
a. determining a species of tree that is best suited for the soil type of a location selected to plant the urban forest; and
b. planting the determined species of tree.

11. A method of creating more resilient urban forests comprising the steps of:
a. selecting a species of tree that survives best with the average rainfall, temperature, and soil composition in a location the urban forest is intended to be planted;
b. digging a tree pit, for a plurality of trees of the selected species;
c. planting a tree of the selected species in the tree pit;
d. digging a plurality of soil conduits extending from roots of the planted trees toward: root systems of other urban trees,
e. inoculating soil with mycorrhizal fungi; and
f. at least partially filling the soil conduits with the inoculated soil.

12. A more resilient tree architecture in an urban environment comprising:
a. a plurality of soil conduits extending between the roots of the urban trees in an urban environment,
b, wherein the soil conduits are inoculated with a mycorrhizal fungus and form fungal networks between roots of the urban trees.

13. The more resilient tree architecture of claim 12, wherein the soil conduits extend to the surface and have a water permeable top surface.

14. The more resilient tree architecture of claim 12, wherein the soil conduits extend to the surface and have a gas permeable top surface.

15. The more resilient tree architecture of claim 12, wherein each soil conduit has a top surface with a grate at least partially covering its top surface.

16. The more resilient tree architecture of claim 12, wherein the soil conduits include a soil medium through which roots can form.

17. The more resilient tree architecture of claim 16, wherein the soil medium is a horticultural soil.

18. The more resilient tree architecture of claim 12, wherein, the genus of the trees is selected to associate with arbuscular mycorrhizae (AM) fungi to create a common mycorrhizal network (CMN).

19. The more resilient tree architecture of claim 12, wherein genus of the trees is selected to associate with ectomycorrhizae (ECM) fungi to create a CMN.

20. An urban vegetation arrangement comprising:
a. a plurality of plants known to interrelate with a mycorrhizal fungus planted in various locations within an urban environment;
b. a plurality of soil conduits connecting roots of the plants;
c, wherein the soil conduits are shallow, elongated passages that open to the surface, and are filled with a soil conducive to root growth inoculated with the mycorrhizal fungus; and
d. an air and water permeable solid structure on a top side of the conduits functioning to prevent compaction of the contents of the materials in the soil conduits.

21. The urban vegetation arrangement of claim 20, wherein the structure is a grate.
